(19) United States
(12) Patent Application Publication
(10) Pub. No.: US 2008/0239170 A1
(43) Pub. Date: Oct. 2, 2008

(54) LOW PROFILE, HIGH EFFICIENCY PROJECTOR FOR HANDHELD ELECTRONIC DEVICES

(75) Inventors: Tomasz L. Klosowiak, Glenview, IL (US); Xiaodong Xun, Schaumburg, IL (US)

Correspondence Address: MOTOROLA, INC., 1303 EAST ALGONQUIN ROAD, IL01/3RD, SCHAUMBURG, IL, 60196, US

(73) Assignee: MOTOROLA, INC., Schaumburg, IL (US)

(21) Appl. No.: 11/691,021

(22) Filed: Mar. 26, 2007

(51) Int. Cl. H04N 9/31

(52) U.S. Cl. 348/744

(57) ABSTRACT

A low profile projector (102) for handheld devices (100) comprise a spatial light modulator (400) that has an aspect ratio that is increased relative to a standard video format and relative to an image projected by the low profile projector. The reduced height of the spatial light modulator (400) allows it fit within a thin handheld electronic device (100). An anamorphic lens (604,700) reduces the aspect ratio of the projected image relative to the aspect ratio of the spatial light modulator (400).

### FIELD OF THE INVENTION

The present invention relates generally to video and image projection, and in particular to projectors for use in compact handheld devices.

### BACKGROUND

Perennial improvements in digital electronics, as described by Moore's Law, delivered forth the ubiquitous personal computer which has computing power comparable to supercomputers of the not so distant past, and for which a myriad of business, engineering, communication, entertainment and other applications have been developed.

At present, the unceasing progress in digital electronics has further progressed computer technology and brought forth handheld devices (e.g., smartphones) with sufficient computing power to run many of the most popular applications that have been run on personal computers. However, one limiting factor in migration of many applications to handheld devices, is the limited screen size of handheld devices, which makes protracted use of many applications (e.g., spreadsheets, text editing) impractical if not impossible.

It has previously been proposed to incorporate a small video projector within handheld electronic devices. FIG. 2 shows a handheld device with built in video projector being used to project a relatively large computer display image on a wall so that the displayed image can be easily viewed by two or more people. The current trend toward making handheld devices smaller and in particular thinner poses challenges to the proposition of including video projectors within handheld devices, particularly if it is desired to include a high resolution video projector within a handheld device.

### BRIEF DESCRIPTION OF THE FIGURES

The accompanying figures, where like reference numerals refer to identical or functionally similar elements throughout the separate views and which together with the detailed description below are incorporated in and form part of the specification, serve to further illustrate various embodiments and to explain various principles and advantages all in accordance with the present invention.

FIG. 1 is a thin smartphone with a built-in video projector according to an embodiment of the invention;

FIG. 2 depicts a mode of use of the thin smartphone with built-in projector shown in FIG. 1;

FIG. 3 is graph of the shortest dimension of spatial light modulators versus pixel count in mega pixels;

FIG. 4 shows an electronic spatial light modulator that has a transverse dimension elongated and a height dimension reduced relative to a standard video format that the spatial light modulator is used to project;

FIG. 5 is a plan view of a pixel of the spatial light modulator shown in FIG. 4 according to an embodiment of the invention;

FIG. 6 is a block diagram of a projector that uses the electronic spatial light modulator shown in FIGS. 4-5;

FIG. 7 is a top view of an example of a lens that can be used in embodiments of the invention; and

FIG. 8 is a side view of the lens shown in FIG. 7.

Skilled artisans will appreciate that elements in the figures are illustrated for simplicity and clarity and have not necessarily been drawn to scale. For example, the dimensions of some of the elements in the figures may be exaggerated relative to other elements to help to improve understanding of embodiments of the present invention.

### DETAILED DESCRIPTION

Before describing in detail embodiments that are in accordance with the present invention, it should be observed that the embodiments reside primarily in combinations of method steps and apparatus components related to projectors. Accordingly, the apparatus components and method steps have been represented where appropriate by conventional symbols in the drawings, showing only those specific details that are pertinent to understanding the embodiments of the present invention so as not to obscure the disclosure with details that will be readily apparent to those of ordinary skill in the art having the benefit of the description herein.

In this document, relational terms such as first and second, top and bottom, and the like may be used solely to distinguish one entity or action from another entity or action without necessarily requiring or implying any actual such relationship or order between such entities or actions. The terms “comprises,” “comprising,” or any other variation thereof, are intended to cover a non-exclusive inclusion, such that a process, method, article, or apparatus that comprises a list of elements does not include only those elements but may include other elements not expressly listed or inherent to such process, method, article, or apparatus. An element preceded by “comprises . . . a” does not, without more constraints, preclude the existence of additional identical elements in the process, method, article, or apparatus that comprises the element.

It will be appreciated that embodiments of the invention described herein may be comprised of one or more conventional processors and unique stored program instructions that control the one or more processors to implement, in conjunction with certain non-processor circuits, some, most, or all of the functions of image processing for video projection described herein. The non-processor circuits may include, but are not limited to, a radio receiver, a radio transmitter, signal drivers, clock circuits, power source circuits, and user input devices. As such, these functions may be interpreted as steps of a method to perform image processing for video projection. Alternatively, some or all functions could be implemented by a state machine that has no stored program instructions, or in one or more application specific integrated circuits (ASICs), in which each function or some combinations of certain of the functions are implemented as custom logic. Of course, a combination of the two approaches could be used. Thus, methods and means for these functions have been described herein. Further, it is expected that one of ordinary skill, notwithstanding possibly significant effort and many design choices motivated by, for example, available time, current technology, and economic considerations, when guided by the concepts and principles disclosed herein will be readily capable of generating such software instructions and programs and ICs with minimal experimentation.

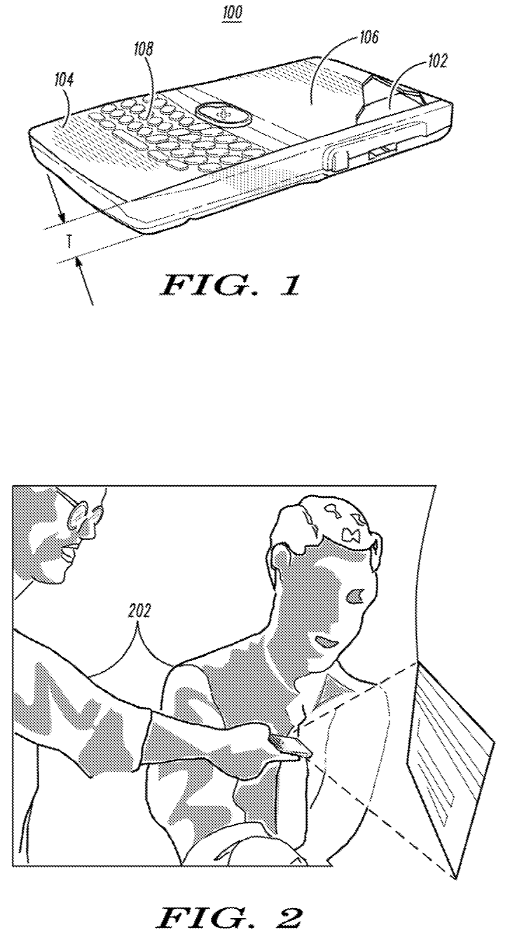

FIG. 1 is a thin smartphone 100 with a built-in video projector 102 according to an embodiment of the invention. Although a smartphone 100 is shown in FIG. 1 and described below, the teachings herein may be applied to other types of devices including, but not limited, portable video game consoles, Personal Digital Assistants, portable video game players, handheld computers and other communication devices. The smartphone 100 has a small thickness, T, so that it can be conveniently carried in a pocket or purse and therefore the built-in video projector 102 must also be made thin. (The thickness, T is the smallest dimension of the smartphone 100.) As shown in FIG. 1 the smartphone 100 includes a housing 104, a built-in Liquid Crystal Display (LCD) 106 and a keypad 108. FIG. 2 depicts a mode of use of the thin smartphone 100 with built-in projector 102 shown in FIG. 1. The projector 102 supplements the small LCD 106 of the smartphone 100. The projector 102 facilitates viewing of information received at, or stored in the smartphone by multiple users 202. One possible (if not necessary) arrangement of a projector is such that an optical axis of a lens (discussed further below) of the projector 102 is parallel to the plane of the smartphone 100, and a spatial light modulator is located in a object plane of the aforementioned lens, the object plane being perpendicular to the plane of the smartphone. In such an arrangement at least one dimension (e.g., the height) of the light modulator is restricted by the thickness T of the smartphone 100. The goal of improved image fidelity dictates the use of higher resolution spatial light modulators. However, for a given aspect ratio (e.g., 4/3) and given pixel size, as resolution increases so does height which then dictates a greater handheld device thickness.

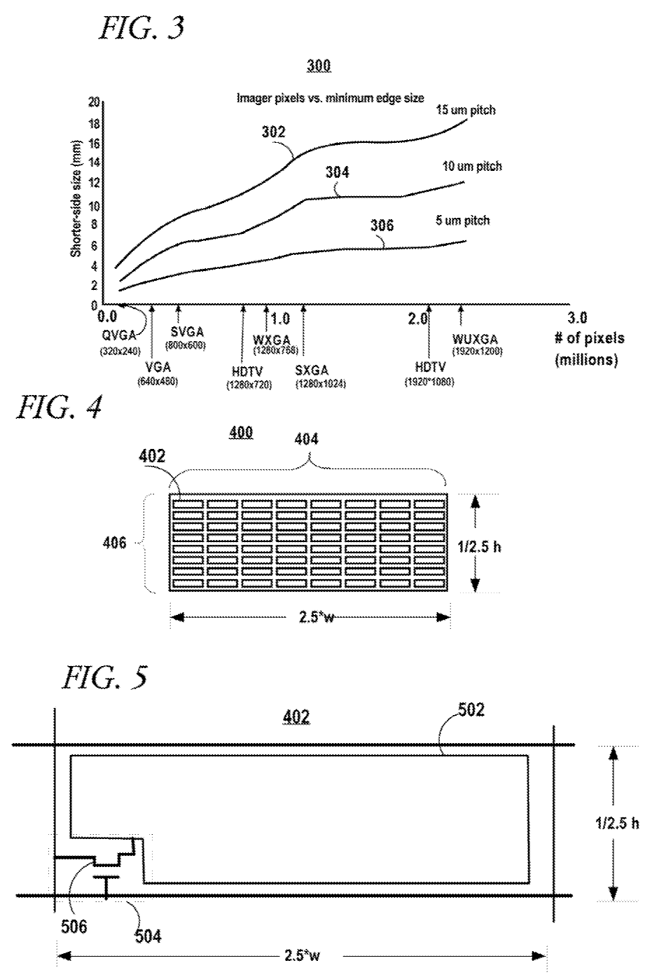

FIG. 3 is graph 300 of the shortest dimension of spatial light modulators versus pixel count in megapixels. Various standard video format dimensions are marked along the abscissa of the graph 300. The graph 300 includes a first plot 302 for 15 micron pixel pitch modulators, a second plot 304 for 10 micron pixel pitch modulators, and a third plot 306 for 5 micron pixel pitch modulators. Smaller pixel pitches are generally associated with reduced transmission efficiency because a dark area associated with the pixel drive electronics can not be proportionally reduced. Consequently there is an incentive to use a larger pixel pitch in the interest of achieving brighter projectors, however this is opposed by the desire to limit the thickness of the device in which the projector is incorporated.

Referring to the graph it is seen that for microdisplays ranging from 320×240 up to 1920×1200 the shortest dimension varies from about 2 mm to about 18 mm. In reviewing the graph 300 it should be kept in mind that handheld electronic devices are typically between 5 mm and 20 mm thick and that some high end models are characterized by thickness in the lower end of this range. In the case of clamshell or slider type devices a projector would typically be accommodated in one of two relatively moveable parts of the device, and the thickness of these parts is on average one-half of the total thickness. Moreover, a few millimeters must be added to the ordinate of the graph 300 to allow for the thickness of, at least, the housing walls of the handheld device, if not for other supporting structure as well. In a tight fit in a thin handheld device (or thin part of a multi-part, e.g., clam, slide type device) the height of the spatial light modulator will typically be at least 80% of the thickness of the part of the housing of the handheld device, in which the spatial light modulator is accommodated.

FIG. 4 is a schematic front view of an electronic spatial light modulator 400 that has an aspect ratio increased by a factor of 6.25 relative to a standard video format that the spatial light modulator 400 is used to generate. The spatial light modulator 400 has a height that is reduced by a factor of 2.5 and a width that is increased by a factor of 2.5. Reducing the height by a factor of 2.5 (or another factor) facilitates fitting a projector that includes the spatial light modulator 400 into a thin handheld electronic device (e.g., smartphone 100). Aligning the reduced height of the spatial light modulator 400 with the thickness direction of the smartphone 100 allows an upright image to be projected while holding the smartphone 100 in a horizontal plane with the keypad visible and accessible to the users 202.

The spatial light modulator 400 has a plurality of oblong pixels 402 arranged in a plurality of columns 404 of pixels and a plurality of rows 406 of pixels. Each pixel has the same aspect ratio as a factor by which an aspect ratio of the spatial light modulator 400 is increased relative to a standard video format.

FIG. 5 is a plan view of one of the pixels 402 of the spatial light modulator 400 shown in FIG. 4 according to an embodiment of the invention. As shown in FIG. 5 the depicted pixel 402 includes an active area that includes a transparent electrode 502 and an optically inactive area 504 that is occupied by a pixel drive transistor 506. A minimum size of the pixel transistor is determined by transistor technology considerations. The ratio of the active area to the total area (sum of active area and optically inactive area 504) is a factor in the light transmission efficiency of the spatial light modulator 400. Good efficiency is important to achieving bright projection displays. By increasing the transverse dimension of the pixels by a factor equal to the factor (e.g., 2.5) by which the height is reduced, the pixel area is conserved, and moreover the ratio of the ratio of active area to total area is conserved. The spatial light modulator 400 suitably comprises a liquid crystal device.

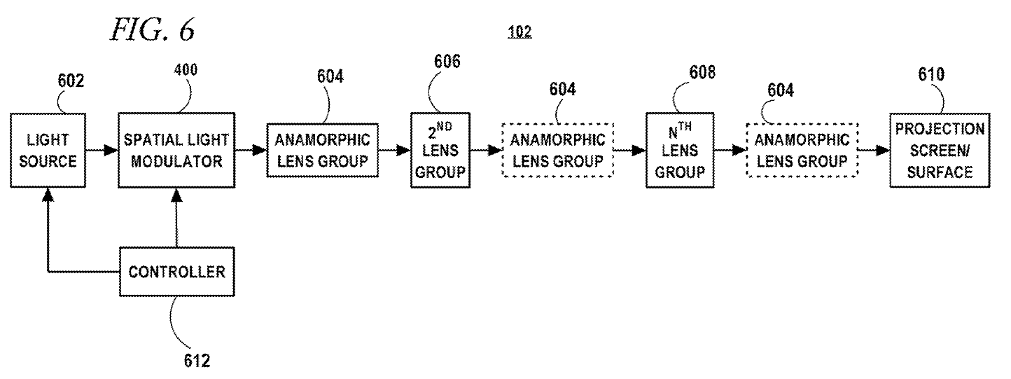

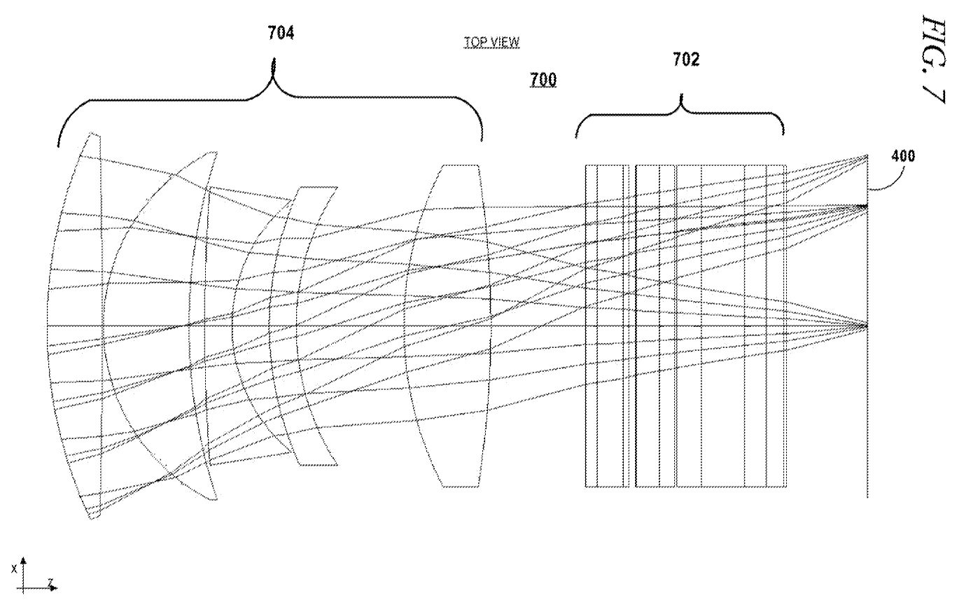

FIG. 6 is a block diagram of the projector 102 that uses the electronic spatial light modulator shown in FIGS. 4-5. The projector 102 comprises a light source 602 optically coupled to the spatial light modulator 400. The light source 602 can for example comprise one or more Light Emitting Diodes. Spatially modulated light produced by the spatial light modulator 400 is optically coupled through an anamorphic lens group 604, a second lens group 606 and an NTH lens group 608 to a projection screen/surface 610. Although three lens groups 604, 606, 608 are shown in FIG. 6 for purposes of illustration, alternatively a different number of lens groups are used. Alternative positions for the anamorphic lens group 604 are shown in dashed outline boxes in FIG. 6. Although only the one anamorphic lens group 604 is shown in FIG. 6, alternatively more than one anamorphic lens group 604 is used. The anamorphic lens group 604 serves to reduce the aspect ratio of an image formed on the projection screen/surface 610 relative to the aspect ratio of the spatial light modulator 400. The lens groups 604 serve to image the oblong pixels of the spatial light modulator 400 to reduced aspect ratio pixel areas on the projection screen/surface. According to embodiments suitable for most standard video formats the aspect ratio of the pixel areas on the screen will be unity. The resulting entire image formed on the projection screen/surface 610 suitably has an aspect ratio of a standard video format.

A controller 612 is coupled to the spatial light modulator 400 and the light source. The controller 612 drives the spatial light modulator according to video information. Optionally, in the case of a field sequential color system the controller 612 also drives the light source (which can include multiple separate color light sources) to periodically emit colors in coordination with the video information supplied to the spatial light modulator 400.

The design of anamorphic lenses is known to persons of ordinary skill in the art and is discussed in various books such as, for example, “Modern Optical Engineering” by Warren J. Smith, McGraw Hill 1990.

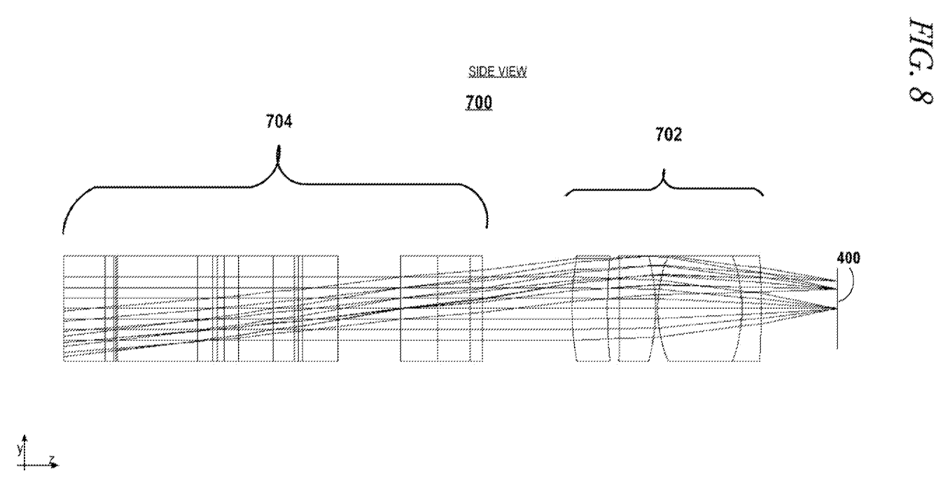

FIG. 7 is a top view of an example of a lens 700 that can be used in embodiments of the invention and FIG. 8 is a side view of the lens shown in FIG. 7.

Table I describes the lens 700.

TABLE I

| Surface | Type | Radius Y | Radius X | Thickness | Material | Aperture Y | Apertuer X |
|---|---|---|---|---|---|---|---|
| IMAGE | STANDARD | Infinity | 0.000 | Infinity | | | |
| 1 | BICONICX | Infinity | 16.798 | 2.070 | ACRYLIC | 4.20 | 14.45 |
| 2 | BICONICX | Infinity | −250.553 | 0.046 | | 4.20 | 14.14 |
| 3 | BICONICX | Infinity | 7.305 | 3.190 | ACRYLIC | 4.20 | 13.00 |
| 4 | BICONICX | Infinity | 20.558 | 0.589 | | 4.20 | 13.00 |
| STOP X | BICONICX | Infinity | 70.192 | 1.013 | POLYSTYR | 4.20 | 10.40 |
| 6 | BICONICX | Infinity | 6.090 | 1.400 | | 4.20 | 9.40 |
| 7 | BICONICX | Infinity | 12.462 | 1.001 | POLYSTYR | 4.20 | 10.40 |
| 8 | BICONICX | Infinity | 9.501 | 4.023 | | 4.20 | 10.40 |
| STOP Y | BICONICX | Infinity | 13.008 | 3.239 | ACRYLIC | 4.20 | 12.00 |
| 10 | BICONICX | Infinity | −39.049 | 3.557 | | 4.20 | 12.00 |
| 11 | BICONICY | 10.856 | Infinity | 1.403 | BK7 | 4.20 | 12.00 |
| 12 | BICONICY | 22.102 | Infinity | 0.466 | | 4.20 | 12.00 |
| 13 | BICONICY | −416.319 | Infinity | 1.441 | BK7 | 4.20 | 12.00 |
| 14 | BICONICY | −8.207 | Infinity | 0.087 | | 4.20 | 12.00 |
| 15 | BICONICY | 5.465 | Infinity | 3.338 | BK7 | 4.20 | 12.00 |
| 16 | BICONICY | −5.894 | Infinity | 0.756 | SF63 | 4.20 | 12.00 |
| 17 | BICONICY | −39.411 | Infinity | 3.025 | | 4.20 | 12.00 |
| SLM | STANDARD | Infinity | Infinity | | | 2.44 | 12.80 |

The lens 700 was designed for an image modulator having an aspect ratio of 6:1. The high aspect ratio is apparent by comparing the width of the dimension of the of spatial light modulator 400 shown in FIG. 7 to that shown in FIG. 8. FIG. 7 shows an X-Z plane view, while FIG. 8 shows an Y-Z plane view. The Y axis is to be aligned with the thickness T dimension of the smartphone 100. The lens 700 includes a first group 702 with curvatures in the Y-Z plane and a second group 704 with curvatures in the X-Z plane. According to this design imaging functions for the X coordinate and Y coordinate are largely separated. However according to alternative designs, lens elements that have curvature in both planes (toroidal) are used.

In the foregoing specification, specific embodiments of the present invention have been described. However, one of ordinary skill in the art appreciates that various modifications and changes can be made without departing from the scope of the present invention as set forth in the claims below. Accordingly, the specification and figures are to be regarded in an illustrative rather than a restrictive sense, and all such modifications are intended to be included within the scope of present invention. The benefits, advantages, solutions to problems, and any element(s) that may cause any benefit, advantage, or solution to occur or become more pronounced are not to be construed as a critical, required, or essential features or elements of any or all the claims. The invention is defined solely by the appended claims including any amendments made during the pendency of this application and all equivalents of those claims as issued.

We claim:

1. A projector comprising:
a spatial light modulator for imagewise modulating light, wherein said spatial light modulator comprises an array of oblong pixels, including a plurality of rows of pixels and a plurality of columns of pixels, and wherein each oblong pixel has an aspect ratio; and
an anamorphic optical device optically coupled to said spatial light modulator, whereby said anamorphic optical device forms an image of said array of pixels wherein said aspect ratio is altered.

2. The projector according to claim 1 wherein said anamorphic optical device forms images of said oblong pixels wherein said images have an aspect ratio of unity.

3. The projector according to claim 1 wherein said spatial light modulator comprises a liquid crystal device.

4. The projector according to claim 1 wherein said aspect ratio is a width to height ratio and is at least four-to-one.

5. The projector according to claim 4 wherein said aspect ratio is at least six-to-one.

6. The projector according to claim 1 further comprising:
a non-anamorphic optical device optically coupled to said anamorphic optical device.

7. The projector according to claim 6 wherein said anamorphic optical device is disposed between said spatial light modulator and said non-anamorphic optical device.

8. The projector according to claim 1 wherein said anamorphic optical device comprises an anamorphic lens.

9. A handheld electronic device comprising said projector according to claim 1.

10. The handheld electronic device according to claim 9 having a thickness T wherein said spatial light modulator has a height dimension h that is arranged parallel to the thickness T of the handheld electronic device and wherein h is at least 80% of T.
